(19) United States
(12) Patent Application Publication
(10) Pub. No.: US 2020/0263116 A1
(43) Pub. Date: Aug. 20, 2020

(54) 'High' Flavoured Beverage Component, Use Thereof and Method of Preparing Such Beverage Component

(71) Applicant: Anheuser-Busch InBev S.A., Brussels (BE)

(72) Inventors: Ben Souffriau, Leuven (BE); Philippe Malcorps, Leuven (BE); Luk Daenen, Leuven (BE)

(21) Appl. No.: 16/637,867

(22) PCT Filed: Aug. 8, 2018
(86) PCT No.: PCT/EP2018/071475

§ 371 Date: Feb. 10, 2020

(30) Foreign Application Priority Data
Aug. 8, 2017 (BE) 2017-5548

(51) Int. Cl. C12C 5/02; C12C 3/10; C12G 3/06; A23L 2/56; A23L 27/24

(52) U.S. Cl. CPC C12C 5/026; C12C 3/10; A23V 2002/00; A23L 2/56; A23L 27/24; C12G 3/06

(57) ABSTRACT

Method for preparing a beverage component, the method comprising the steps of: (a) Providing an aqueous suspension comprising at least 1.5 g/l, preferably at least 3 g/l, most preferably at least 5 g/l hops or hop products and fermentable carbohydrates; (b) Fermenting the aqueous suspension with a yeast to obtain the beverage component, characterized in that the aqueous suspension comprises an amount of free amino nitrogen (FAN) of less than 11 ppm FAN/° Pl, preferably less than 6 ppm FAN/° Pl, most preferably less than 4.5 ppm FAN/° Pl, at the start of fermentation and/or that aqueous suspension comprises an amount of free amino nitrogen (FAN) of less than 180 ppm, preferably less than 100 ppm, most preferably less than 85 ppm.

### FIELD OF THE INVENTION

The present invention concerns a method of preparing a fermented beverage having a relatively strong hop based flavour profile, in particular allows for a relatively high biotransformation of hop flavour precursors to odourant and volatile flavours. The present invention further also concerns such ‘high’ flavoured beverage component as well as the use thereof.

### BACKGROUND TO THE INVENTION

The present invention concerns a method of preparing a fermented, hop flavoured beverage component that, as an example, can be used in preparing beverages by mixing one or more beverage components with a beverage base such as water or beer, in particular, the invention aims at a beverage component having a high concentration of volatile flavour components originating from hops.

Research has shown that hops contain far more flavour components than the ones extracted during dry hopping of beer. However, a large part of the flavour components are chemically bound to entities in the hop and/or are present as flavour precursors in a non-volatile and non-odourant form that has to be released and/or converted into a volatile and odourant form resulting in effectively flavouring beer. These hop flavour precursors can be chemically assigned to two major types: S-conjugates of thiol and glycoside conjugates of aglycones.

Conversion of S-conjugate precursors and glycoside conjugate precursors to, respectively, volatile and odourant thiols and aglycones can be performed by brewer's yeast in the fermentation tank, however in case of adding hops to the fermentation tank in a late stage of fermentation or even during maturation, as is common practice in dry hopping processes, no or insufficient viable yeast is present to perform effective conversion of the hop flavour precursors. In case one would add aromatic hops in an earlier stage of fermentation when sufficient viable yeast is present, the yeast biotransformation is thought to release less than 5% of the available hop aromas.

It will be appreciated from the above that there remains a market need for improving the efficiency and the perhaps even more importantly the potential of dry hopping in terms of the diversity of type and amount of flavours to be added to beer.

### SUMMARY OF THE INVENTION

The present invention addresses the above market need by providing a method allowing to unlock a whole class or range of currently overlooked flavours provided to the beer during dry hopping. The present invention is defined in the appended independent claims. Preferred embodiments are defined in the dependent claims.

In particular, the invention concerns a method for preparing a beverage component, the method comprising the steps of:

(a) Providing an aqueous suspension comprising at least 1.5 g/l, preferably at least 3 g/l, most preferably at least 5 g/l hops or hop products and fermentable carbohydrates;

(b) Fermenting the aqueous suspension with a yeast to obtain the beverage component, characterized in that the aqueous suspension comprises an amount of free amino nitrogen (FAN) of less than 11 ppm FAN/° Pl, preferably less than 6 ppm FANPPI, most preferably less than 4.5 ppm FAN/° Pl, at the start of fermentation and/or that aqueous suspension comprises an amount of free amino nitrogen (FAN) of less than 180 ppm, preferably less than 100 ppm, most preferably less than 85 ppm.

While in a regular beer fermentation, the yeast biotransformation of is thought to release less than 5% of the available hop aromas S-conjugate precursors and glycoside conjugate precursors to, respectively, volatile and odourant thiols and aglycones is low, it has been surprisingly observed that when adding hops or hop products and in particular CO₂ extracted hops to a fermentation broth with a low FAN availability for the yeast, biotransformation of S-conjugate precursors and/or glycoside conjugate precursors to volatile and odourant thiols and/or aglycones is increased, allowing preparation of highly flavoured beverage components. Such beverage component can be dosed/mixed in/with a beverage or diluent to alter the taste profile of a beverage.

In a preferred method of the invention, the aqueous suspension comprises less than 30 ppm iso-alfa-acids, preferably less than 20 ppm iso-alfa-acids, most preferably less than 15 ppm at the start of fermentation.

The hop or hop products, in particular CO₂ extracted hops, preferably have an alfa-acids content of maximally 3 w %, preferably maximally 2 w %.

The fermentation preferably is performed under low-oxygen or anaerobic conditions.

The hops can be provided in the aqueous solution as extracted hops, total hops, hop pellets, hop extracts [preferably CO₂ extracted hops and most preferably supercritical CO₂ extracted hops], spent hops and or mixtures thereof.

According to a preferred method, the aqueous suspension has an original extract in the range of 10-25° Pl.

The source of fermentable carbohydrates is preferably selected from the group comprising: cereal, malt, wort, fermented beer, apple juice, high maltose syrup, high glucose syrup and/or mixtures thereof, more preferably, the sugar source comprises a mixture of mashed malt and high maltose syrup (HMS) in a malt/HMS ratio of 50/50 or less.

In some cases boiling of the aqueous suspension before fermentation is preferred, while the acidity of the aqueous suspension during suspension of the hop material in the aqueous suspension preferably ranges between a pH of 2 and 7 or even better between 2 and 5.

Finally the invention concerns the use of a beverage component obtained by a method as described above or having a composition in line with the above requirements

### BRIEF DESCRIPTION OF THE FIGURES

FIG. 1 shows a graph of the results of a sensory test for hop varietal effects of beverage components prepared by fermenting a hop suspension with varying amounts of free amino nitrogen (FAN) concentrations at the start of fermentation.

FIG. 2 shows a graph of a sensory test for hop varietal effects of beverage components prepared by fermenting a hop suspension with varying amounts of free amino nitrogen (FAN) concentrations at the start of fermentation, in view of the pH of the beverage component.

### Definitions

For the sake of the present invention, CO₂ extracted hops are defined as the hop solids obtained after CO₂ extraction of hops, these CO₂ extracted hops typically are by-product of beer production.

Spent hops are defined as the hop solids that remain after a water extraction of hops at high temperature (above 80° C.). An example of spent hops is the hop material that is filtered out of the wort after boiling when transferring the wort from the boiling vessel to the fermentation tank.

FAN or free amino nitrogen is a measure of the concentration of individual amino acids and small peptides (one to three units) which can be utilized by beer yeast for cell growth and proliferation. For the sake of this invention, ammonium salts, such as di-ammonium phosphate (DAP), and proline are not considered as FAN. FAN levels will be expressed in either absolute numbers (g/l) or in relative amounts as a ratio of FAN concentration per specific gravity of wort (expressed in degrees Plato) (ppm/° Pl).

The start of the fermentation (primary fermentation) is defined as the moment at which yeast is pitched in the wort to allow yeast propagation and, in a later stage, conversion of the sugars in the wort into alcohol.

For the sake of this invention iso-alfa acids are considered all iso-alfa acids and their derived products such tetrahydro-iso-alfa acids.

### DETAILED DESCRIPTION OF A PREFERRED EMBODIMENT

The present invention is based on the surprising effect of fermenting a fermentable carbohydrate suspension comprising a high load of CO₂ extracted hops but with a limited concentration of free amino acids in the suspension.

As mentioned in the background section, the biotransformation of aroma precursors to actual volatile and odourant compounds, in particular, aglycones, thiols and terpenes, during a regular beer fermentation is very low. However, it has now been found that when limiting the amount of FAN in the fermentation broth at the start of fermentation, biotransformation of the aroma precursors can be increased significantly.

The method according to the present invention essentially comprises of:
(a) providing an aqueous suspension (wort) of hops at a concentration of at least 1.5 g/l, preferably at least 3 g/l and most preferably at least 5 g/l CO₂ extracted hops, fermentable carbohydrates (in particular glucose, maltose and maltotriose), and a relatively low concentration of free amino nitrogen (FAN) of less than 11 ppm FAN/° Pl of the wort; and
(b) fermenting the above wort with a yeast, preferably a Saccharomyces sp.

In order to better control fermentation, it is preferred that the wort is boiled prior to fermentation.

The low FAN concentration in the wort can be achieved by using low amounts of malt and relative high amounts of adjuncts such as cereals (including corn, wheat, barley, rice, sorghum, oat and/or mixtures) thereof as sugar source, alternatively a high maltose syrup (HMS) and/or high glucose syrup can be used to (partially) replace the adjunct as sugar source. Other alternatives for the adjuncts as sugar source comprise, partially fermented beers, fruit juices such as apple juice and or mixtures of one or more of the adjuncts, HMS, high glucose syrup or other mentioned alternatives (for sake of clarity, the total amount of adjuncts, HMS, high glucose syrup or other mentioned alternatives is further addresses as non-malt sugar source). The ratio of malt/non-malt sugar source is preferably 50/50 or lower, even up to 0/100. The total amount of FAN/° Pl in the wort preferably ranges between 0.5 ppm/° Pl and 11 ppm/° Pl, most preferably between 0.5 and 4.5° Pl.

Alternatively, low FAN concentration in the wort can be obtained by mashing malt without proteolysis step (which is typically done at 45-55° C.). In such case, the mashing process starts with a mash-in at temperatures corresponding to a proteolytic rest temperature (typically 62-67° C., also referred to as amylase rest temperature). By omitting the proteolysis step, low FAN levels per degree Plato at higher malt percentage can be reached. Again, the total amount of FAN/° Pl in the wort preferably ranges between 0.5 ppm/° Pl and 11 ppm/° Pl, most preferably between 0.5 and 4.5° Pl.

The hops or hop derivates can be chosen from both aromatic or high alpha hop cultivars or dual-purpose hop cultivars, in particular from one or more of the following hop varieties: Sorachi Ace, Nelson Sauvin, Tomahawk, Citra, Saaz, Mozaik, Centennial, Apollo, Taurus, Teamaker, Hercules, Magnum. In accordance with the present invention, the amount of hops present in the wort is at least 1.5 g/l, preferably at least 3 g/l and most preferably at least 5 g/l. The hops can be added untreated to the wort or can be added as a spent hops or CO₂ extracted hops.

For the method of the invention it is preferred that the hops added to the wort are very low in alpha or are supercritical CO₂ extracted hops, such that the total amount of alfa-acids in the wort do not exceed 30 ppm iso-alfa-acids, preferably less than 20 ppm iso-alfa-acids, most preferably less than 15 ppm at the start of fermentation. This allows reducing the bitterness of the resulting beverage component. To achieve the above maximum levels of iso-alfa-acids, it is preferred to use hop products having an alfa-acid content of below 3 w %, preferably below 2 w %.

The acidity of the wort at start of the fermentation preferably ranges between a pH of 7 and 2, most preferably between 5 and 2 as it is believed that low pH in the wort further improves hop varietal flavour effects.

The fermentation is preferably performed under low-oxygen or anaerobic conditions.

After fermentation the fermented liquid is collected that is addressed here as a beverage component. Optionally the beverage component can be filtered prior to use and/or the pH of the beverage component can be adjusted to a level ranging from 2.8 to 3.8, preferably to a level ranging from 3 to 3.5, more preferably 3 to 3.3, most preferably to a level of 3.2. Surprisingly, it has been found that acidifying the beverage or beverage component to a pH below 3.8 and preferably below 3.3 enhances the overall flavour stability and, even more surprisingly, the hop flavour stability. Where in regular strongly hopped or dry hopped beers, the hop flavour reduces after 1 to 2 months, the beverage or beverage component of the present invention, when acidified, is found to maintain its hop flavour for periods of over 12 months.

The beverage component prepared by a method according to the invention, preferably has a low bitterness and comprises an iso-alfa acid content of 15 ppm or lower, preferably 10 ppm or lower.

According to the present invention the beverage component can be used as a beverage as such or as a component to be mixed/dosed in another liquid such as beer, cereal based fermented liquids, cider, water and/or combinations thereof. The mixing ratio of the beverage component of the invention with another liquid can be chosen at will by the consumer, yet preferably ranges in a beverage component/liquid ratio of at least 20/80, or even at least 25/75, with a preferred range of 25/75 and 35/65.

To allow ageing of the beverage component, which in this case includes remediation of a potential unpleasant bitterness of the beverage or beverage component, it is preferred to allow the beverage component to an ageing in bottle, keg, wooden barrels, stainless steel tanks, etc. for 2-10 weeks.

### EXAMPLE

As an example, several batches of wort were prepared, each having a specific gravity of approximately 17.5° Pl. The batches were prepared such as to have different FAN concentrations ranging from about 370 mg/l (=21.1 ppm/° Pl) (=100 w % malt extract) to 0 mg/l (=0 ppm/° Pl) (0 w % malt extract, 100 w % HMS or high glucose syrup). In each of the wort batches 5 g/l hops were added which roughly corresponds to approximately 4 g/l CO₂ extracted hops. In this case the hop variety was the same for all batches, an Apollo hop

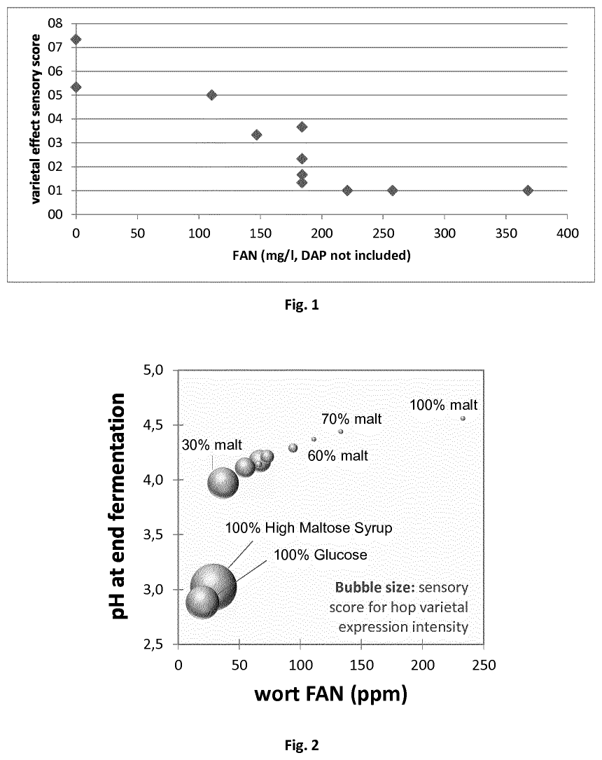

After fermentation, the fermented liquid of each batch was filtered to obtain a beverage component that was tasted by a sensory panel. The results of sensory test are shown in the graph of FIG. 1. This graph surprisingly shows the effect on the hop varietal flavour effects of low FAN levels in the wort at the start of fermentation, whereby improved hop varietal flavour effects were detected when the FAN levels in the wort at the start of fermentation were below 11 ppm/° Pl, whereas these effects were absent with higher FAN levels. Hop varietal flavour effects reported by the sensory panel for the above beverage component include: lychee, tropical fruits, grapefruit, pineapple, citrusy, elderflower and sauvignon blanc.

It was further noticed that potential unpleasant bitterness of the beverage or beverage component can be remediated by ageing in bottle, keg, wooden barrels, stainless steel tanks, etc. for 2-10 weeks.

1. A Method for preparing a beverage component, the method comprising the steps of:
(a) providing an aqueous suspension comprising at least 1.5 g/l hops or hop products and fermentable carbohydrates; and
(b) fermenting the aqueous suspension with a yeast to obtain the beverage component,
characterized in that the aqueous suspension comprises an amount of free amino nitrogen (FAN) of less than 11 ppm FAN/° Pl at the start of fermentation and/or that aqueous suspension comprises an amount of free amino nitrogen (FAN) of less than 180 ppm.

2. The method according to claim 1, wherein the aqueous solution comprises less than 30 ppm iso-alfa-acids, at the start of fermentation.

3. The method according to claim 1, wherein the hop or hop products have an alfa-acids content of maximally 3 w %.

4. The method according to claim 1, wherein the hop or hop products are CO₂ extracted hops.

5. The method according to claim 1, wherein the fermentation is performed under low-oxygen or anaerobic conditions.

6. The method according to claim 1, wherein the fermentable carbohydrates originate from cereal, malt, wort, fermented beer, apple juice, high maltose syrup, high glucose syrup and/or mixtures thereof.

7. The method according to claim 1, wherein the fermentable carbohydrates comprise a mixture of mashed malt and high maltose syrup (HMS) in a malt/HMS ratio of 50/50 or less.

8. The method according to claim 1, wherein the amount of FAN in the aqueous solution at the start of fermentation is comprised between 0.5 and 11 ppm FAN/° Pl.

9. The method according to claim 1, wherein the pH of the aqueous solution at the start of the fermentation is between 7 and 2.

10. The method according to claim 1, further comprising a step of adjusting the pH of the fermented beverage component to a level ranging from 2.8 to 3.8.

11. A beverage component prepared by a method according to claim 1, having an iso-alfa acid content of 15 ppm or lower.

12. Use of the beverage component as prepared by the method of claim 1 for preparing a beverage by mixing the beverage component with a liquid.

13. Use according to claim 12, the liquid is beer or a cereal based fermented product, a cider, water and/or combinations thereof.

14. Use according to claim 12, comprising mixing the beverage component with a liquid in the beverage component/liquid ratio of at least 20/80.

15. (canceled)

16. The method according to claim 1, wherein the hops or hop products and fermentable carbohydrates is at least 5 g/l.

17. The method according to claim 1, wherein the FAN is less than 4.5 ppm FAN/° Pl.

18. The method according to claim 1, wherein the amount of FAN is less than 85 ppm.

19. The method according to claim 2, wherein the aqueous solution comprises less than 15 ppm iso-alfa-acids at the start of fermentation.

20. The method according to claim 3, wherein the hop or hop products have an alfa-acids content of maximally 2 w %.

21. The method according to claim 4, wherein the hop or hop products are supercritical CO₂ extracted hops.

22. The method according to claim 8, wherein the amount of FAN in the aqueous solution at the start of fermentation is comprised between 0.5 and 4.5 ppm FAN/° Pl.

23. The method according to claim 9, wherein the pH of the aqueous solution at the start of the fermentation is between 5 and 2.

24. The method according to claim 10, wherein the level ranges from 3 to 3.3.

25. The beverage component according to claim 11 having an iso-alfa acid content of 10 ppm or lower.

26. The use according to claim 14, wherein the beverage component/liquid ratio is between 25/75 and 35/65.
